(19) United States
(12) Patent Application Publication
(10) Pub. No.: US 2006/0143297 A1
(43) Pub. Date: Jun. 29, 2006

(54) Mobile communication terminal, system and method therefore

(76) Inventors: Panu Korhonen, Helsinki (FI); Mika Roykkee, Pirkkala (FI); Juha Kaario, Tampere (FI); Ramalingam Hariharan, Tampere (FI); Veera Lattunen, Helsinki (FI); Aki P. Happonen, Kiiminki (FI)

Correspondence Address: PERMAN & GREEN, 425 POST ROAD, FAIRFIELD, CT, 06824, US

(21) Appl. No.: 11/023,128

(22) Filed: Dec. 27, 2004

(51) Int. Cl. G06F 15/16

(52) U.S. Cl. 709/227

(57) ABSTRACT

A method for providing user interface data controlling a multimedial layout of a user interface for a mobile telecommunications terminal is disclosed. The method comprises generating at least one user interface data set in a first mobile telecommunications terminal, receiving data relating to at least a portion of the user interface data set, from the first mobile telecommunications terminal, in a server coupled to the first mobile telecommunications terminal, receiving a first request, in the server, for the user interface data set, from a second mobile telecommunications terminal coupled to the server, and transferring the user interface data set to the second mobile telecommunications terminal as a result of the first request.

### BACKGROUND OF THE INVENTION

1. Field of the Invention

The present invention generally relates to mobile telecommunication terminals, and more specifically to a method, system and apparatus for facilitating modification of a user interface for a mobile telecommunications terminal.

2. Brief Description of Related Developments

Mobile telecommunications terminals are becoming a necessity in positive terms in the everyday life of many people. The functionality of modern mobile telecommunications terminals increases rapidly, e.g. with the addition of digital cameras and digital calendars in mobile telephones, which makes mobile telecommunications terminals attractive to persons who previously had no reason for using a mobile telecommunications terminal. With the increased number of people using mobile telecommunications terminals in public areas, the greater risk a user has of confusing his or her own mobile telecommunications terminal with somebody else's mobile telecommunications terminal due to the increased possibility that both mobile telecommunications terminals are of the same brand and the same model. The risk of mixing up two mobile telecommunications terminals is particularly imminent in e.g. a locker room, a conference hall, a restaurant etc.

In order for a user to reduce the risk of mixing up his or her mobile' telecommunications terminal with other user's mobile telecommunications terminals, the user must personalize the mobile telecommunications terminal in some way. One way of personalizing the mobile telecommunications terminal is to change the casing of the mobile telecommunications terminal. Today it is possible to buy a specific model of a mobile telecommunications terminal and subsequently exchange the original casing for another casing of a different color. The mobile telecommunications terminal will hence to some extent be personalized by the exchanged casing. However, the number of different exchange casings available for a specific model of a mobile telecommunications terminal is limited still providing the risk of mixing up two different mobile telecommunications terminals.

Another approach to personalize the mobile telecommunications' terminal is to use one of normally a plurality of predefined so called “themes” in the mobile telecommunications terminal. For example, in many mobile telecommunications terminals in the form of mobile telephones it is possible -to simultaneous change a background image displayed on a screen in the mobile telephone and the ringtones used for indicating an incoming telephone call or an incoming message (such as SMS, EMS, MMS etc). The theme thus comprises a specification of how the mobile telephone shall operate in regards to the user interface. In addition to the themes stored in the mobile telecommunications terminal, the user may also be provided with the possibility to download further themes from a server in a network via e.g. an internet web site.

Even though the predefined themes and the downloaded themes described above give the user an opportunity to personalize the mobile telecommunications terminal to some degree, it is by far not sufficient in regards to providing the user with a unique user interface of the mobile telecommunications terminal. Although the themes in many cases provide enough distinctive features of the mobile telecommunications terminal so as to allow the user to identify his or her mobile telecommunications terminal, the themes do not fully answer to the human need for expressing herself. This need is by way of example also apparent from numerous car and motorcycle customizations, personalized multimedial layout of personal computers, design of clothes etc.

Another problem is when a user of a mobile telecommunications terminal, who has personalized the user interface of the mobile telecommunications terminal, i.e. in some way changed how a person perceives the mobile telecommunications terminal as to its behavior, look, sound capabilities etc, and who wants to share the personalized user interface with another user. The only possibility to share any user interface data today is to physically show the mobile telecommunications terminal for the other person. Although the user may send e.g.-an image to another user by means of e.g. MMS or email, he or she has no provisions for transmitting a bundle of specifications forming a complete user interface.

There is hence a need for a easily accessible and reliable method, system and apparatus for generating and sharing user interface data for mobile telecommunications terminals.

### SUMMARY OF THE INVENTION

An object of the present invention is to overcome the above-described problems of the known technologies in regard to sharing of user interface data.

The above objects, advantages and features together with numerous other objects, advantages and features, which will become evident from the detailed description below, are obtained according to a first aspect of the present invention by a method for providing user interface data controlling a multimedial layout of a user interface for a mobile telecommunications terminal, said method comprising:

generating at least one user interface data set in a first mobile telecommunications terminal,

receiving data relating to at least a portion of the user interface data set, from the first mobile telecommunications terminal, in a server coupled to the first mobile telecommunications terminal,

receiving a first request, in the server, for the user interface data set, from a second mobile telecommunications terminal coupled to the server, and

transferring the user interface data set to the second mobile telecommunications terminal as a result of said first request.

The method hence makes it possible for a user of a first mobile telecommunications terminal to create a user interface and make it available to other users by publishing the user interface data on a server. The user of the first mobile telecommunications terminal may decide to publish data relating to a portion of the user interface, e.g. a screen shot, in order to keep control of the distribution of the user interface. A user of a second mobile telecommunications terminal may then review the user interface in its complete or reduced form on the server and send a request to the server for obtaining the user interface data set. The server may then send the user interface data set to the second mobile telecommunications terminal if the server holds the entire user interface data set, or may provide for the first mobile telecommunications terminal to send the user interface data set to the second mobile telecommunications terminal.

The server may receive the user interface data set from the first mobile telecommunications terminal and transfer the user interface data set to the second mobile telecommunications terminal as a result of said first request, i.e. the server may act as buffer for the complete user interface data set, wherein the first mobile telecommunications terminal need not to hold the entire user interface data set.

The server may prior to receiving the user interface data set transfer a second request for the user interface data set to the first mobile telecommunications terminal, i.e. the server may initially only hold the screen shot and request the complete user interface data set from the first mobile telecommunications terminal only on demand.

The method may comprise:

receiving at least one password from the server, in the second mobile telecommunications terminal, as a result of said first request,

receiving the password from the second mobile telecommunications terminal, in the first mobile telecommunications terminal, and

transferring the user interface data set from the first mobile telecommunications terminal to the second mobile telecommunications terminal if the password authorizes access to the user interface data set in the first mobile telecommunications terminal.

The user interface data set may hence in a secure way be requested by the second mobile telecommunications terminal and transferred from the first mobile telecommunications terminal to the second mobile telecommunications terminal without buffering the data on the server. The user interface data set may moreover be transferred by means of a wireless communication protocol, which makes it possible for the user of the first mobile telecommunications terminal to share the user interface data set with the user of the second mobile telecommunications terminal without the need for additional hardware, such a computer with a modem.

The above objects, advantages and features together with numerous other objects, advantages and features are obtained according to a second aspect of the present invention by a system for providing user interface data controlling a multimedial layout of a user interface for a mobile telecommunications terminal, said system comprising:

a network,

a server coupled to the network,

a first mobile telecommunications terminal coupled to the network and adapted to generate at least one user interface data set and transfer data related to at least a portion of the user interface data set to the server,

a second mobile telecommunications terminal coupled to the network and adapted to transmit a first request for the user interface data set to the server and to receive the user interface data set as a result of said first request.

The sharing of user interface data between different mobile telecommunications terminals hence becomes very easy with a system according to a preferred embodiment of the present invention.

The server may be adapted to receive the user interface data set from the first mobile telecommunications terminal and to transfer the user interface data set to the second mobile telecommunications terminal as a result of receiving said first request. The server may hence act as buffer for the complete user interface data set wherein the first mobile telecommunications terminal need not to hold the entire user interface data set.

The server may be adapted to transfer a second request for the user interface data set to the first mobile telecommunications terminal prior to receiving the user interface data set. The server may hence initially only hold the screen shot and request the complete user interface data set from the first mobile telecommunications terminal only on demand.

According to one embodiment of the system the second mobile telecommunications terminal may be adapted to receive at least one password from the server and to transfer the password to the first mobile telecommunications terminal, wherein the first mobile telecommunications terminal may be adapted to transfer the user interface data set to the second mobile telecommunications terminal if the password authorizes access to the user interface data set in the first mobile telecommunications terminal. The user interface data set may hence in a secure way be requested by the second mobile telecommunications terminal and transferred from the first mobile telecommunications terminal to the second mobile telecommunications terminal without buffering the data on the server.

The above objects, advantages and features together with numerous other objects, advantages and features are obtained according to a third aspect of the present invention by a mobile telecommunications terminal comprising:

an input unit,

a control unit connected to the input unit, said control unit being adapted to receive configuration data from the input unit, and in response to the received configuration data generate at least one user interface data set controlling a multimedial layout of a user interface for a mobile telecommunications terminal,

a transceiver connected to the control unit and adapted to transmit the user interface data set via a wireless communication protocol.

A user of the mobile telecommunications terminal may hence use the input unit for generating configuration data, e.g. by selecting and providing properties for objects which are to be part of the user interface. Alternatively, the configuration data may be provided to the control unit from an external source, such as a personal computer, via the input unit. The control unit may then investigate the configuration data and generate a user interface data set in a language, such as XML, which is easily transferable to other platforms.

The mobile telecommunications terminal may comprise:

a display, and

a memory connected to the display and comprising figure data corresponding to one or more figures presentable on the display,

wherein the control unit is adapted to use said configuration data for pointing out at least a portion of said figure data in the memory and to display the at least a portion of said figure data on the display.

The user may hence generate configuration data by using the input unit for selecting one or more figures (i.e. images, characters, numbers, etc.) from a plurality of figures which are stored in the memory and displaying them on the display in order to generate a user interface.

The control unit may be adapted to use said configuration data for defining one or more coordinates on the display and to display the at least a portion of said figure data on the display at said coordinates.

It is hence possible to select graphical objects and arrange them on the display in order to generate a user interface.

The mobile telecommunications terminal may comprise:

an audio unit,

a memory connected to the audio unit and comprising audio data corresponding to one or more audio sequences,

wherein the control unit is adapted to use said configuration data for pointing out at least a portion of said audio data in the memory and to play back the at least a portion of said audio data in the audio unit. It is hence possible to incorporate audio features in the user interface.

The control unit may be adapted to generate said user interface data set from the at least a portion of said figure data. The control unit may hence be adapted to create a complete graphical user interface or e.g. a screen shot of user interface which may be used for illustrating the appearance of the user interface.

The control unit may be adapted to generate said user interface data set from the at least a portion of said audio data. The control unit may hence be adapted to create a user interface with fully functional audio capabilities or e.g. a sample sound file of user interface which may be used for illustrating the appearance of the user interface.

The mobile telecommunications terminal may comprise:

a housing, and

one or more controls arranged in the mobile telecommunications terminal, said controls being accessible from the outside of the housing and coupled to the input unit,

wherein the input unit is adapted to generate the configuration data as a result of an actuation of at least one of the one or more controls.

The user may hence generate a user interface data set without any additional hardware.

The input unit may be adapted to communicate with a personal computer and to receive the configuration data from the computer.

It is hence possible for a user of a mobile telecommunications terminal to generate the configuration data for the user interface on a personal computer and thereafter transfer the data to the mobile telecommunications terminal.

The mobile telecommunications terminal may comprise:

display means, and

a memory connected to the display means and comprising visualization data presentable by means of the display means,

wherein the control unit is adapted to use said configuration data for pointing out at least a portion of said visualization data in the memory for presentment of the at least a portion of said visualization data by means of the display.

The mobile telecommunications terminal may hence be provided with additional display means, such as additional light sources (light-emitting diodes, small lamps etc.) which may become part of the user interface. The additional display means may hence be used for personalizing the mobile telecommunications terminal.

### BRIEF DESCRIPTION OF THE DRAWINGS

Further objects, features and advantages of the present invention will become apparent upon consideration of the following detailed description in conjunction with the appended drawings.

FIG. 1 illustrates a mobile telecommunications system for providing user interface data according to one embodiment of the present invention.

FIG. 2 illustrates a mobile telecommunication terminal according to the present invention.

FIG. 3 is a schematic block diagram of the different parts of a mobile telecommunication terminal according to a preferred embodiment of the present invention.

FIG. 4 illustrates graphic layout of a program for generating a user interface data set according to one embodiment of the present invention.

FIG. 5 is an illustration in more detail of a method for generating user interface data according to one embodiment of the present invention.

FIG. 6 is an illustration in more detail of a method for providing user interface data according to one embodiment of the present invention.

FIG. 7 is an illustration in more detail of a method for providing user interface data according to another embodiment of the present invention.

### DETAILED DESCRIPTION OF THE PREFERRED EMBODIMENT(S)

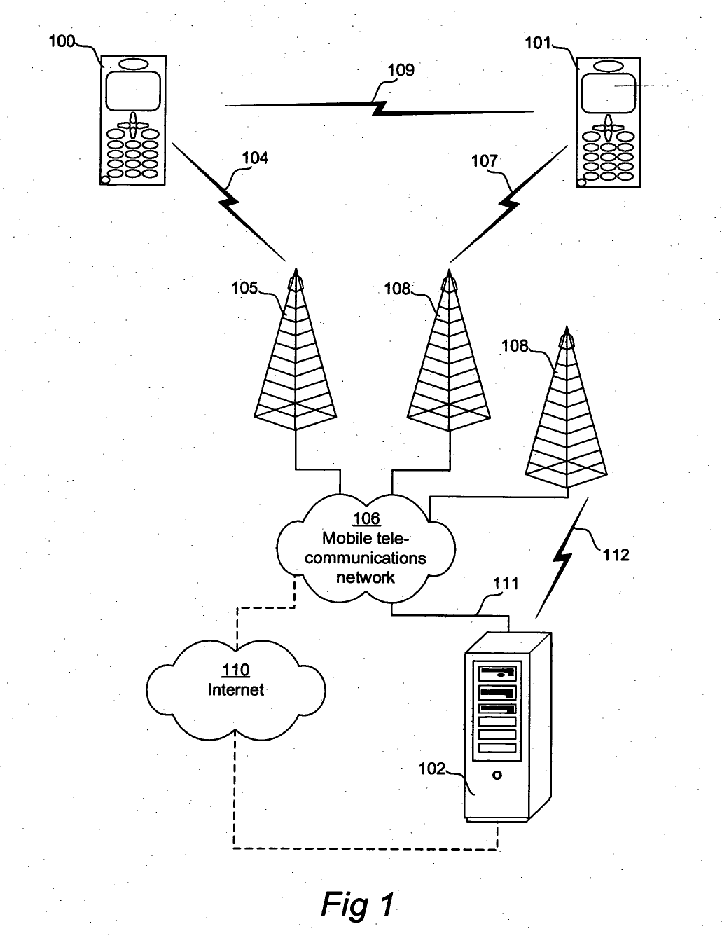

FIG. 1 illustrates a mobile telecommunications system in which the present invention may be applied. As shown in the figure, a first mobile telecommunications terminal 100 may communicate with a second mobile telecommunications terminal 101 or a server 102 via a wireless link 104, a base station 105 and a mobile telecommunications network 106. Likewise may the second mobile telecommunications terminal 101 communicate with the first mobile telecommunications terminal 100 or the server 102 via a wireless link 107, a base station 108 and the mobile telecommunications network 106.

The first mobile telecommunications terminal 100 and the second mobile telecommunications terminal 101 are preferably adapted to operate in a mobile telecommunications system such as UMTS, GSM, or D-AMPS. It is however appreciated that operation in other mobile telecommunication systems is equally possible depending on the infrastructure in respect of mobile telecommunications provided in the area in which the mobile telecommunications terminals 100, 101 are located. The first mobile telecommunications terminal 100 and second mobile telecommunications terminal 101 may be adapted to operate in different mobile telecommunications systems and interconnected via an interface in the mobile telecommunications network 106 (not shown). This may be the case in areas where a system belonging to a new generation of mobile telecommunications (e.g. UMTS) has not been fully implemented and interacts with an older system for mobile telecommunications (such as GSM).

Additionally, the first mobile telecommunications terminal 100 and second mobile telecommunications terminal 101 may be adapted to communicate directly with each other by means of a short range wireless communication link 109, such as Bluetooth, WLAN (Wireless Local Area Network, e.g. as specified in IEEE 802.11), HomeRF or HIPERLAN.

The server 102 may be adapted to communicate with the mobile telecommunications network 106 via the Internet 110 as indicated by the dashed line in FIG. 1. The server may also be adapted to communicate directly with the mobile telecommunications network 106 by means of cable 111, or via a short range (such as WLAN) or long range (such as UMTS) wireless link 112 depending on the environment in which the server is located.

As will be disclosed in more detail below, the first mobile telecommunications terminal 100 is adapted to generate a user interface data set, which may control the audiovisual behavior of the first mobile telecommunications terminal 100, and transfer all or portions the user interface data set to the server 102 via the first wireless link 104 and the mobile telecommunications network 106. A user of the second mobile telecommunications terminal 101 may then gain access to all or portions of the user interface data set stored on the server via the second wireless link 108 and the mobile telecommunications network 106. The user interface data set may be requested by the second mobile telecommunications terminal 101 and transferred to the second mobile telecommunications terminal 101 from the server 102 via the mobile telecommunications network 106 and the wireless link 107. In case the server only holds portions of the user interface data set, the server 102 may request a complete user interface data set from the first mobile telecommunications terminal 100 prior to processing the request from the second mobile telecommunications terminal 101.

Alternatively, the second mobile telecommunications terminal 101 may directly request the user interface data set from the first mobile telecommunications terminal 100, wherein the user interface data set is transferred to the second mobile telecommunications terminal 101 directly from the first mobile telecommunications terminal 100 via the first wireless link 104, the mobile telecommunications network 106 and the second wireless link 107 (e.g. by means of GPRS). The transfer of the user interface data set may alternatively be provided via the short range communication link 109.

In case the user interface data set is to be transferred from the first mobile telecommunications terminal 100 to the second mobile telecommunications terminal 101 without buffering the user interface data set on the server, the second mobile telecommunications terminal 101 is preferably first authenticated on the server (i.e. the user of the second mobile telecommunications terminal 101 becomes a registered user of the services provided by the server), whereupon the server transfers a password to the second mobile telecommunications terminal 101. The password may then be used by the second mobile telecommunications terminal 101 as authentication when the second mobile telecommunications terminal 101 requests the user interface data set directly from the first mobile telecommunications terminal 100.

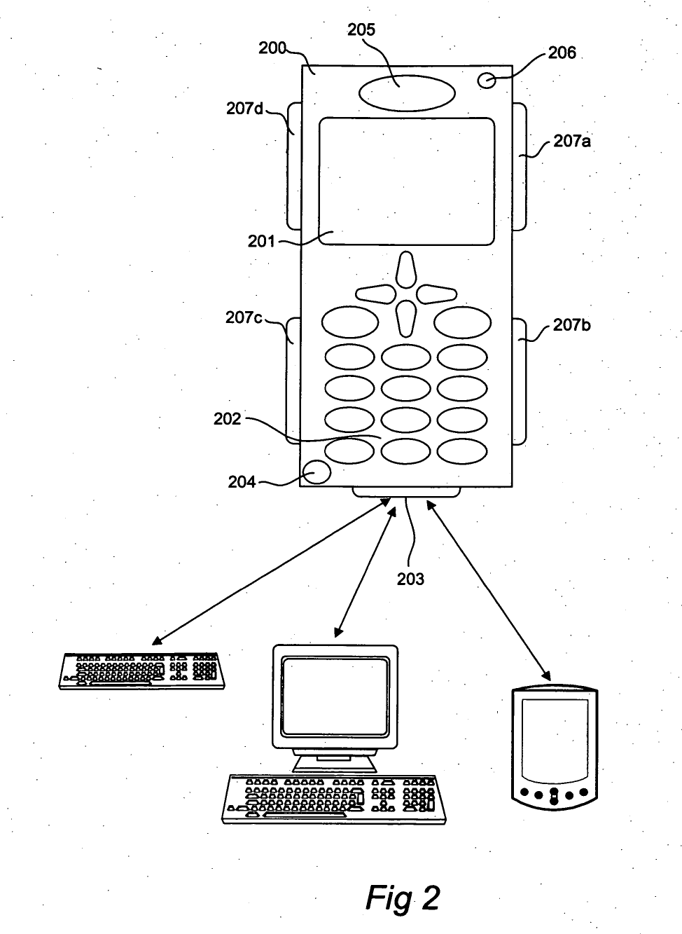

FIG. 2 illustrates a mobile telecommunications terminal 200 according to a preferred embodiment of the present invention. The mobile telecommunications terminal 200 preferably comprises a display 201 for presenting information, e.g. regarding the current operational status of the mobile telecommunications terminal 200, to the user of the mobile telecommunications terminal 200. The display 201 may for instance also be used for displaying names and telephone numbers stored in a memory in the mobile telecommunications terminal 200, graphical images, icons, video sequences, graphical game interfaces, etc.

The mobile telecommunications terminal 200 also preferably comprises an input unit 202 which may be in the form of a keyboard; an on-screen touch-sensitive keyboard; a navigation wheel or joystick for scrolling and selecting items, digits and/or characters shown on the display 201; etc. The input unit 202 may be integral with the mobile telecommunications terminal 200 or separate from the mobile telecommunications terminal 200, wherein the input unit 202 is connected to the mobile telecommunications terminal 200 when needed. The input unit 202 in the mobile telecommunications terminal 200 may alternatively be in the form of e.g. an integral navigation wheel for normal use as well as a connector 203 for connecting the mobile telecommunications terminal 200 to an external data source e.g. in the form of a full-size keyboard, a personal computer, a personal digital assistant, etc.

It is appreciated that the relative size of the display 201 is not restricted to the embodiment shown in FIG. 2; the display may be a touch-sensitive display covering most of the front of the mobile telecommunications terminal 200, wherein the display substitutes the keyboard shown in FIG. 2 and instead provides a keyboard 202 as a graphical, touch-sensitive image on the display 201.

The input unit 202 may be adapted to emit light in different colors. The keyboard shown in FIG. 2 may be manufactured from a semi-transparent polymer which allows light to pass through the buttons on the keyboard, wherein the light emitted by the keyboard may be provided by light emitting diodes or small lamps arranged inside the mobile telecommunications terminal 200.

The mobile telecommunications terminal 200 preferably comprises a microphone 204 which picks up audio data (speech) from the user of the mobile telecommunications terminal 200. The audio data is then processed in the mobile telecommunication terminal 200 according to techniques known per se depending on which type of mobile telecommunication network the mobile telecommunication terminal is operating in (e.g. the audio data may be vocoded in order to save bandwitdh of the wireless communication link 104). The speech of the user is thereafter transferred to another user via the wireless communication link 104 and the mobile telecommunications network 106.

The mobile telecommunications terminal 200 preferably comprises a loudspeaker 205 for playing back audio data received in the mobile telecommunication terminal 200 via the wireless communication link 104. The loudspeaker 205 may also be used for playing back audio data generated in the mobile telecommunications terminal 200 (such as music composed by the user of the mobile telecommunications terminal 200, or sound generated by an electronic game running in the mobile telecommunications terminal 200) or stored in the mobile telecommunications terminal 200 (such as music downloaded to the mobile telecommunications terminal 200).

The mobile telecommunications terminal 200 may comprise other display means such as a light emitting diode or small lamp 206 which may be used for indicating a current battery status of a battery (not shown) in the mobile telecommunications terminal 200 in that it emits light of different colors, blinking at different rates etc depending on the amount of power preserved in the battery. The light emitting diode 206 may also be used for indicating that a specific person is calling. That is, a user of the mobile telecommunications terminal 200 may set the light emitting diode to flash in a predetermined color when the specific person calls the mobile telecommunications terminal 200.

Additionally, the mobile telecommunications terminal 200 may be provided with additional display means 207a-d which are used for customizing the appearance of the mobile telecommunications terminal 200. All or some of the additional display means 207a-d may be adapted to emit continuous or flashing light in many different colors, emit light only during an ongoing communication via the wireless communication link 104, emit continuous or flashing light when the mobile telecommunications terminal 200 is called by another party, etc. The additional display means 207a-d are preferably manufactured by means of uncolored plastic covers and multi-colored light sources, such as one or more light emitting diodes of different colors arranged together, or by means of colored plastic covers and neutral light sources.

The cover of the mobile telecommunications terminal 200 may be manufactured from a conductive polymer which is adapted to change its color depending on am electric field applied to the cover. Polymers which change their color in the visible spectrum in the presence of a static or dynamic electrical field have been disclosed in e.g. “Tunable Multicolor Electroluminescent Polymer Devices for Full Color Displays” by Samson A. Jenekhe and Xuejun Zhang, ROCHESTER UNIV NY DEPT OF CHEMICAL ENGINEERING, Report number A099663. The user of the mobile telecommunications terminal 200 may hence set the cover to change color when e.g. the mobile telecommunications terminal 200 receives a call from another user terminal, when an alarm in the mobile telecommunications terminal 200 is activated, etc.

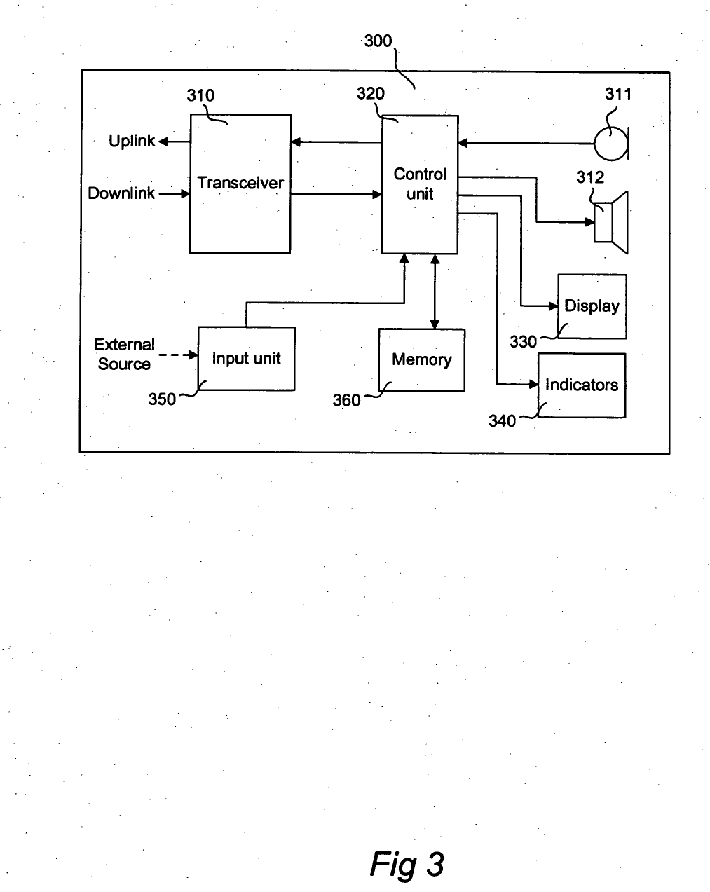

FIG. 3 is a schematic block diagram of a mobile telecommunication terminal 300 according to a preferred embodiment of the present invention. A transceiver 310 is used for communicating with the base station 105. The base station 105 may in turn communicate with other mobile telecommunications terminals 101 or a server 102 via a mobile communications network 106 as disclosed above. The transceiver 310 may be arranged to operate in various frequency bands, such as 880-915 MHz and 925-960 MHz (GSM900), 1710-1785 MHz and 1805-1880 MHz (GSM1800), 1850-1910 MHz and 1930-1990 MHz (GSM1900), and 1885-2025 MHz and 2110-2200 MHz (UMTS). It is however appreciated that other frequency bands are equally possible depending on the specifications of the network in which the mobile telecommunication terminal 300 is to operate.

A control unit 320 is coupled to the transceiver 310. The control unit 320 may comprise signal processing circuitry in order to process e.g. voice data provided by a microphone 311 and provide the transceiver 310 with the processed data for transmission to the base station 105. Likewise, the control unit 320 may comprise signal processing circuitry for processing data received from another telecommunications terminal 101 in order to provide a loudspeaker 312 with audio data. Alternatively (not shown) some or all of the signal processing functionality may be provided by specialized circuitry in the mobile telecommunication terminal 300.

The control unit 320 is coupled to a display 330 for providing a user of the mobile telecommunication terminal 300 with visual data as disclosed above. As will be disclosed in more detail below, the display 330 may in particular display graphics forming a part of an adaptable user interface. The control unit is also coupled to an indicator 340 or other display means used for customizing the appearance of the mobile telecommunications terminal 200

The control unit 320 is moreover coupled to an input unit 350, which may be in the form of a keyboard etc as disclosed above. The input unit may also be adapted to receive data from an external source as disclosed above and indicated by the dashed line in FIG. 3.

A memory 360 is connected to the control unit 320 and comprises user interface data which may be used to control the multimedial layout of the mobile telecommunications terminal 300, i.e. the manner in which graphic is displayed on the display, how sounds are reproduced by the loudspeaker, the amplification of signals received from the microphone 311, the behavior of the input unit (in case of a keyboard, e.g. the color of light emitted by the keyboard and the delay before the keyboard repeats the output when a key is held down). The user interface data may be provided to the memory 360 from the control unit 320 which in turn has generated the user interface data as a result from configuration data received from the input unit.

The control unit 320 may hence read the user interface data, and software routines for using the data, from the memory 360 for controlling the behavior of the other parts of the mobile telecommunications terminal 300. As will be disclosed in more detail below, the memory 360 may also comprise figure data corresponding to one or more figures presentable on the display, wherein the control unit 320 is adapted to use the configuration data received from the input unit for pointing out one or more of the figures in the memory and to display the figures on the display. The configuration data is also preferably used for defining the coordinates on the display, at which coordinates the figures will be displayed. Moreover, the configuration data may also be used for selecting specific audio data in the memory 360, which data preferably become part of the user interface data. The configuration data may also be used for defining one or more control parameters, such as which font to use for displaying text, amount of amplification to use when amplifying a signal provided by the microphone 311, etc.

As will be disclosed in more detail below, the control unit 320 is preferably adapted to use the figures arranged on the display as well as any selected audio data and control parameters for generating a user interface data set in XML-format (extensible Markup Language) which may be transferred to another mobile telecommunications terminal 101 or the server 102.

It is understood in this context that the memory 360 may be a single memory or many different memories, implemented by means of different technologies (such as RAM, ROM, EPROM, EEPROM, Flash, etc) which all are accessible by the control unit 320.

Besides or as an alternative to controlling the multimedial layout of the mobile telecommunications terminal 300, the control unit 320 may provide the user interface data to the transceiver 310 for transmission of the user interface data to another mobile telecommunications terminal 101 or the server 102 in a manner known per se.

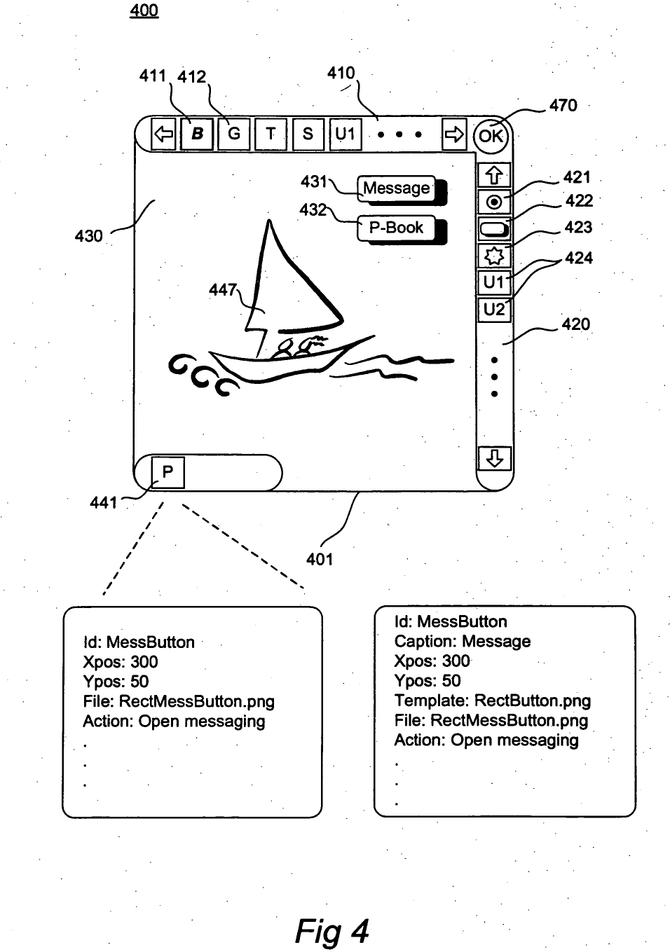

FIG. 4 illustrates by way of example a preferred graphic layout 400, as seen on a display 401 of the mobile telecommunications terminal 200, of a program for generating a user interface data set in the mobile telecommunications terminal 200 according to one embodiment of the present invention.

Starting in the uppermost portion of the figure, a first toolbar 410 is displayed that holds buttons which group different categories of object together. By activating one of the buttons on the top toolbar, a new set of buttons will be displayed on a second toolbar 420, e.g. arranged on the rightmost side of the display 401 as shown in FIG. 4. All buttons displayed on the second toolbar 420 belong to a common category. That is, as shown in this example, the activation of the “B” button (“B” being an abbreviation of “Buttons”) 411 on the first toolbar will display a set of different buttons on the second toolbar 420. A user of the mobile telecommunications terminal 100 may then by means of the input unit select one of the buttons displayed on the second toolbar 420. For example, if the display 401 is of a touch-sensitive type, the user may use a stylus for tapping the screen at the location of the desired button and drag the button out on a drawing area 430 on the screen 401.

The buttons displayed on the second toolbar in FIG. 4 are by way of example: a radio button 421, a rectangular button 422, a star-shaped button 423 and two user-defined buttons 424. The user-defined buttons may be created by a user of the mobile telecommunications terminal 100 and comprise images created in e.g. an icon editor or drawing program in the mobile telecommunications terminal 100. The program for generating a user interface data set according to the present invention may however also provide this functionality, or the images may be photographs or the like transferred to the mobile telecommunications terminal 100 from an external source, such as a personal computer.

When a user has selected a button and placed it on the drawing area 430 by means of the input unit 350 (e.g. by means of a stylus or arrow keys on a keyboard), for example as shown by the buttons “Message” 431 and “P-book” 432, the user may tap a properties button 441 shown in the bottom left corner of the display 401 in FIG. 4, wherein a dialog screen 450 opens on the screen 401, in which the user may set desired parameters for the button (the dialog screen 450 is however shown outside the display 401 in FIG. 4 for reasons of clarity). Examples of parameters to set are “Id” which is used for identifying the specific button amongst other objects on the screen, “Xpos” and “Ypos” which indicates the location of the button on the display 401, “File” which identifies the image to use for the button, “Action” which indicates what will happen when the button is activated. It is appreciated that other properties of the button may be added to the exemplary list in FIG. 4.

As an alternative to using buttons with fixed text information, e.g. “Message” and “P-Book”, the control unit 320 may be adapted to generate the appropriate image file from information provided by the user of the mobile telecommunications terminal 100. More specifically, a dialog screen 460 may contain a reference to a button template, denoted “RectButton.png” in FIG. 4 which is then supplemented by a text string, denoted “Caption” in FIG. 4. A new image file, denoted “RectMessButton.png” in FIG. 4, is created by e.g. superimposing the text string on the button template.

The user of the mobile telecommunications terminal 100 may place other graphical objects on the drawing area by pressing the “G” button 412 which in similarity to the disclosure of the “B” button opens a list of graphical objects (not shown) on the second toolbar 420. The user may then select a graphical image object and e.g. arrange it as a background 433 on the display 401. The second toolbar 420 may comprise objects such as predefined basic shapes (squares, triangles, etc), images downloaded to the mobile telecommunications terminal 100 from an external source, etc as well as drawing tools for drawing shapes directly on the drawing area 430.

The user of the mobile telecommunications terminal 100 may place additional text objects on the display by pressing the “T” button which displays different text tools on the second toolbar 420, such as different fonts, text effects, colors, etc.

The user of the mobile telecommunications terminal 100 may also link different graphical objects or events to specific sound objects which are presented on the second toolbar 420 when the user activates the “S” button in the first toolbar. This may be useful for defining ringtones, alarm sounds, etc that shall be part of the user interface data set. The sound objects may preferably be arranged as graphical objects on the drawing area 430 for making it simple to alter their properties, but are not shown as graphical objects on the display once the editing of the user interface is completed.

The first toolbar 410 may also comprise user-defined buttons, denoted “U1” in FIG. 4, which displays user-specific objects on the second toolbar 420. The user-specific objects may be a grouping of commonly used objects, or special objects, such as downloaded software routines (plug-ins) used for increasing the functionality of the user interface.

When the user has placed all desired objects (graphic, sound, plug-ins etc) on the drawing area 430 he or she activates the “OK” button 470 shown in the upper right corner of the display 401. This will invoke a software routine which investigates all objects on the display 401 as to their function, position, visibility (i.e. as mentioned above are some objects preferably not displayed), identification name, image reference, etc and, as will be disclosed in more detail below, generates an user interface data set based on this investigation. Depending on the complexity of the user interface, permitted by the processing capabilities of the control unit, some graphical objects may be covered by other objects in a layered structure, wherein the coordinates of the objects also includes a layer reference.

The configuration data provided by the user of the mobile telecommunications terminal 100 by means of selecting, placing, and setting properties of objects on the display 401 may alternatively, as disclosed above, be provided to the control unit 320 from an external source, such as a personal computer, via the input unit 350.

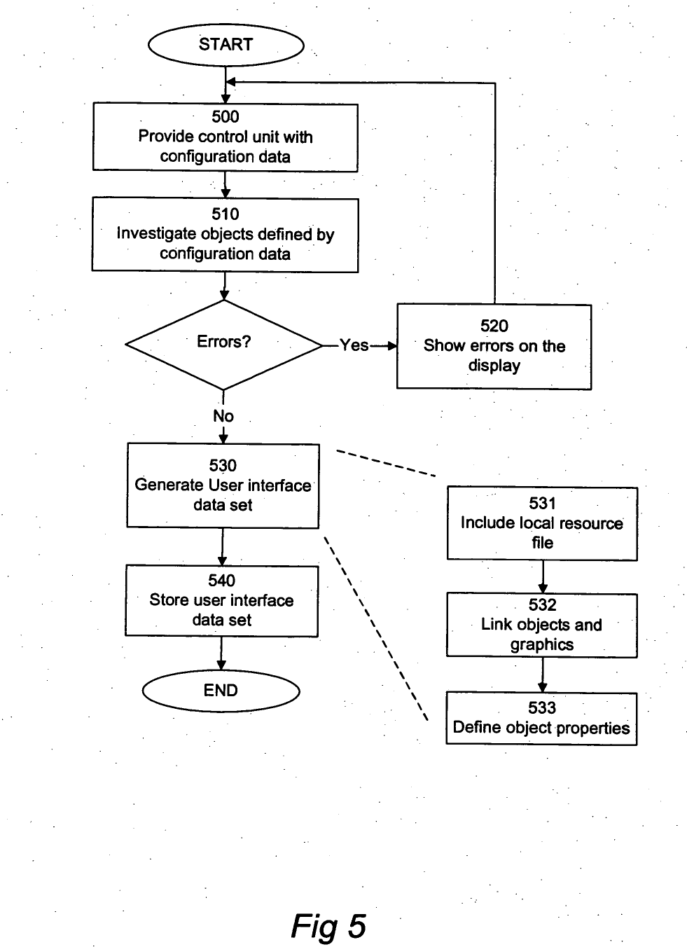

FIG. 5 is an illustration in more detail of a method for generating user interface data according to one embodiment of the present invention.

In step 500, the input unit 350 provides the control unit 360 with configuration data. The control data preferably comprises data describing which objects are to be part of the user interface, which function that will be performed when a user selects a specific object (e.g. sending a message, look for a telephone number in a phone book etc), the position of each object on the display 330, the visibility of each object, the name of each object, the references to any images which are to be displayed, etc. The configuration data may be generated by the input unit as a result of the selection, placement and configuration of the objects, which are stored in the memory 360, by a user of the mobile telecommunications terminal 100 as described above, or the configuration data may be received by the input unit 350 from an external source, such as a personal computer.

In step 510 the control unit 320 investigates the objects defined by the configuration data in order to determine which of the objects that link to programs or other resources in the mobile telecommunications terminal 100. Some of the objects defined in the configuration data may call for action by e.g. a phone book stored in the memory 360 of the mobile telecommunications terminal 100, while other objects may affect the behavior of the display means 207a-d in the mobile telecommunications terminal 100 etc. The memory 360 of the mobile telecommunications terminal 100 preferably comprises a data file defining all resources available in the mobile telecommunications terminal 100. The control unit may hence easily determine if an object links to a resource that is not provided by the mobile telecommunications terminal 100.

If there are any undefined properties or unresolved links found during the investigation, the control unit in step 520 displays an error message on the display and jumps back to step 500 in order to receive more or corrected configuration data.

If no errors are found during the investigation, the control unit continues in step 530 by creating a user interface data set which preferably is a data file formatted as an XML-file for making it easy to share the user interface data set with other people using mobile telecommunications terminals of other models. The XML-file preferably comprises a statement to include a local resource file residing in the mobile telecommunications terminal 101 to which the user interface data set may be transferred. The XML-file moreover preferably comprises a section which links the graphics of the objects to a “bitmap id” that other XML code can refer to. For example, with reference to the discussion in relation to FIG. 4, a bitmap id “MessButton” is preferably in this section linked to a graphics component called “RectMessButton.png”. The XML-file also preferably comprises a section where the properties, defined when the user of the mobile telecommunications terminal 100 generated the configuration data, are declared. Basically, this section comprises the properties entered in the dialog screen 450.

Once the user interface data set is generated by the control unit 320, it is preferably stored, in step 540, in the memory 360 of the mobile telecommunications terminal 100 for subsequent retrieval.

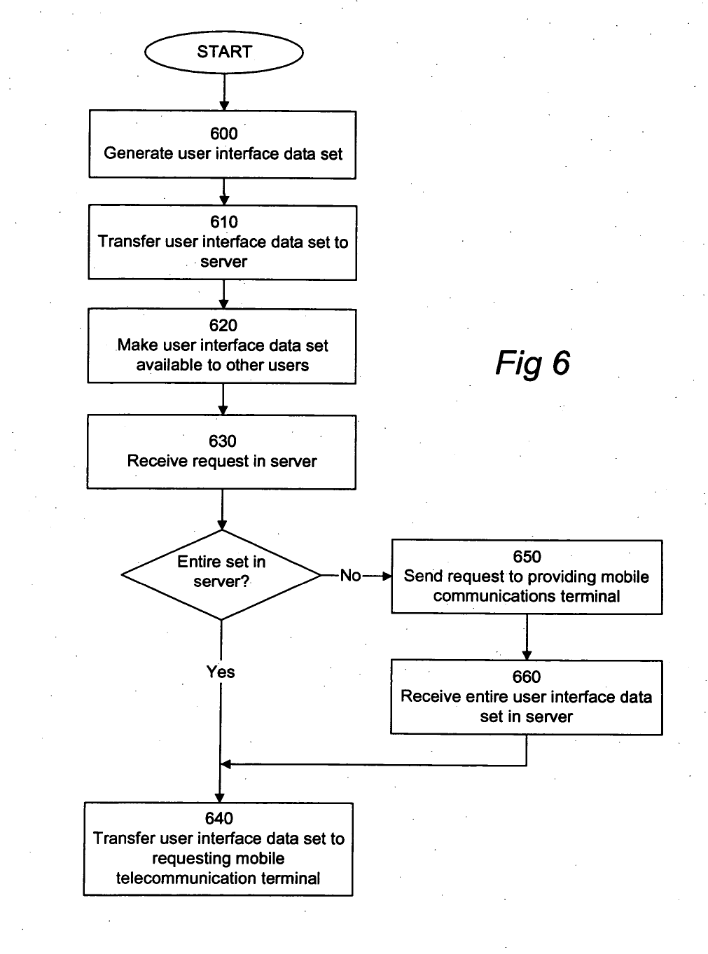

FIG. 6 is an illustration in more detail of a method for providing user interface data according to one embodiment of the present invention.

In step 600 the control unit 320 generates a user interface data set as disclosed above. The memory 360 of the mobile telecommunications terminal 100 may comprise further user interface data sets which a user of the mobile telecommunications terminal 100 has previously generated and stored in the memory. In generating the user interface data set, it is appreciated that the user of the mobile telecommunications terminal 100 may create the entire user interface from scratch, or edit an existing user interface data set. This implies that a user may improve the performance and appearance of an existing user interface, but is still generating a new user interface data set.

In step 610 the user instructs the mobile telecommunications terminal 100 to transfer the user interface data set to the server 102. The user may chose to send the entire user interface data set to the server, or to send just a portion of the data set. The latter case may be useful when the user of the mobile telecommunications terminal 100 wants to keep total control over the distribution of the user interface data set. The portion transferred to the server 102 may be a user interface data set with reduced functionality or simply a screen shot of the user interface.

The server 102 then, in step 620, publishes the user interface data set, wherein the user interface data set becomes available to other users. In this context it is understood that depending on the terms under which the user interface data set, or data relating to the user interface data set, has been transferred to the server 102, the server 102 may make the user interface data set available by being adapted to only provide a screen shot of the user interface, a user interface with reduced functionality, or a complete fully functional user interface.

A user of another mobile telecommunications terminal 101 which likes the user interface published by the server 102, may, in step 630, send a request for a copy of the user interface-data set to the server 102.

If the entire user interface data set is available at the server, and if the terms under which the user interface data set was transferred to the server 102 so allows the server may, in step 640, transfer the user interface data set to the second mobile telecommunications terminal 101 as a result of the request.

If only a portion of the user interface data set or a screen shot of the user interface is available at the server 102, the server may, in step 650, send a request for the entire user interface data set to the first mobile telecommunications terminal 100. The first mobile telecommunications terminal 100 may then, in step 660 transfer the entire user interface data set to the server 102, whereupon the server may transfer the user interface data set to the second mobile telecommunications terminal 101.

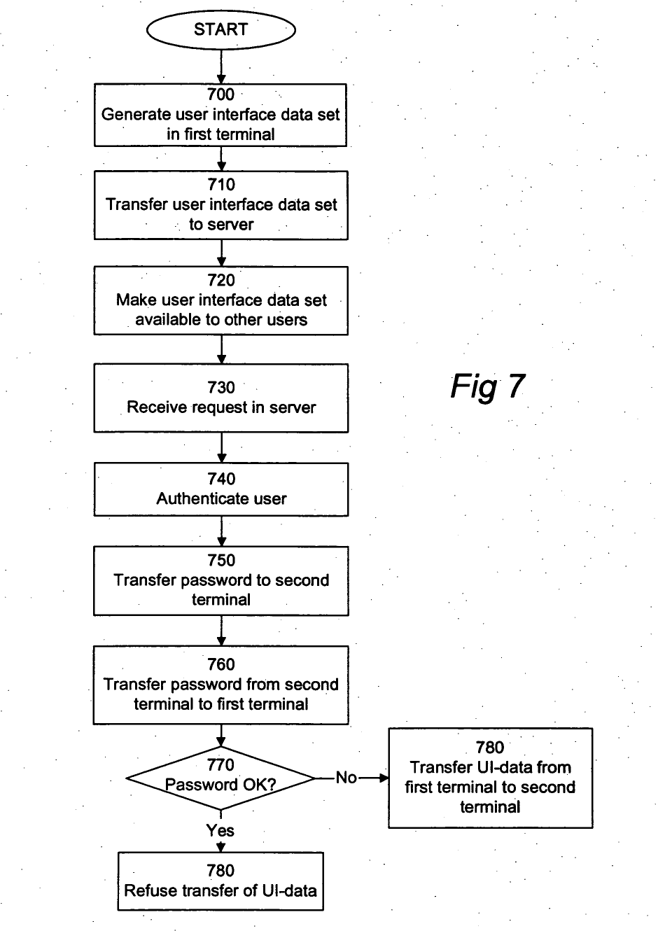

In an alternative embodiment shown in FIG. 7, the steps 700-730 corresponds to steps 600-630 disclosed above.

In step 740 the server authenticates the user of the second mobile telecommunications terminal 101. The authentication may be performed by methods known per se which normally requires that the user is registered and known at the server 102.

In step 750 the server 102 transfers a password to the authenticated user as a proof that the user of the second mobile telecommunications terminal 101 is a registered user on the server 102. The password may be a one-time password which after a successful utilization becomes invalid. Sent together with the password is preferably also an address to the first mobile telecommunications terminal 100, wherein the second mobile telecommunications terminal 101 is provided with the possibility to communicate directly with the first mobile telecommunications terminal 100. It is understood that an unsuccessful authentication results in that no password is transferred to the second mobile telecommunications terminal 101.

In step 760 the second mobile telecommunications terminal 101 transfers the password to the first mobile telecommunications terminal 100 as a request for the user interface data set.

In step 770 the first mobile telecommunications terminal 100 determines if the received password authorizes access to the user interface data set. As mentioned above, the password is a proof that the user of the second mobile telecommunications terminal 101 is a registered user on the server 102 and may comprise data identifying the user of the second mobile telecommunications terminal 101. This data may be used by the first mobile telecommunications terminal 100 to determine if the user interface data set shall be sent to the second mobile telecommunications terminal 101 for free or if the user of the second mobile telecommunications terminal 101 shall be charged for the data sent to him. This step may as well be performed in the server 102 prior to sending the password to the second mobile telecommunications terminal 101.

If the password does not provide access to the user interface data set, the first mobile telecommunications terminal 100 refuses transfer of the data set in step 780.

Otherwise, if the password authorizes access to the user interface data set, the first mobile telecommunications terminal 100, in step 790 transfers the user interface data set to the second mobile telecommunications terminal 101. The transfer is preferably performed by means of a wireless communication protocol, such as GPRS, Bluetooth™, HomeRF, etc as disclosed above.

While the present invention has been particularly shown and described with reference to specific embodiments thereof, it will be understood by those skilled in the art that various changes in form and detail may be made thereto, and that other embodiments of the present invention beyond embodiments specifically described herein may be made or practiced without departing from the spirit and scope of the present invention as limited solely by the appended claims.

1. A method for providing user interface data: controlling a multimedial layout of a user interface for a mobile telecommunications terminal, said method comprising:
generating at least one user interface data set in a first mobile telecommunications terminal,
receiving data relating to at least a portion of the user interface data set, from the first mobile telecommunications terminal, in a server operatively coupled to the first mobile telecommunications terminal,
receiving a first request, in the server, for the user interface data set, from a second mobile
telecommunications terminal coupled to the server, and
transferring the user interface data set to the second mobile telecommunications terminal as a result of said first request.

2. The method according to claim 1, wherein the server receives the user interface data set from the first mobile telecommunications terminal and transfers the user interface data set to the second mobile telecommunications terminal as a result of said first request.

3. The method according to claim 3, wherein the server prior to receiving the user interface data set transfers a second request for the user interface data set to the first mobile telecommunications terminal.

4. The method according to claim 1, comprising:
receiving at least one password from the server, in the second mobile telecommunications terminal, as a result of said first request,
receiving the password from the second mobile telecommunications terminal, in the first mobile telecommunications terminal, and
transferring the user interface data set from the first mobile telecommunications terminal to the second mobile telecommunications terminal if the password authorizes access to the user interface data set in the first mobile telecommunications terminal.

5. The method according to claim 4, wherein the user interface data set is transferred by means of a wireless communication protocol.

6. A system for providing user interface data controlling a multimedial layout of a user interface for a mobile telecommunications terminal, said system comprising:
a network,
a server coupled to the network,
a first mobile telecommunications terminal coupled to the network and adapted to generate at least one user interface data set and transfer data related to at least a portion of the user interface data set to the server,
a second mobile telecommunications terminal coupled to the network and adapted to transmit a first request for the user interface data set to the server and to receive the user interface data set as a result of said first request.

7. The system according to claim 6, wherein the server is adapted to receive the user interface data set from the first mobile telecommunications terminal and to transfer the user interface data set to the second mobile telecommunications terminal as a result of receiving said first request.

8. The system according to claim 7, wherein the server is adapted to transfer a second request for the user interface data set to the first mobile telecommunications terminal prior to receiving the user interface data set.

9. The system according to claim 6, wherein the second mobile telecommunications terminal is adapted to receive at least one password from the server and to transfer the password to the first mobile telecommunications terminal, wherein the first mobile telecommunications terminal is adapted to transfer the user interface data set to the second mobile telecommunications terminal if the password authorizes access to the user interface data set in the first mobile telecommunications terminal.

10. A mobile telecommunications terminal comprising:
an input unit,
a control unit connected to the input unit, said control unit being adapted to receive configuration data from the input unit, and in response to the received configuration data generate at least one user interface data set controlling a multimedial layout of a user interface for a mobile telecommunications terminal and
a transceiver connected to the control unit and adapted to transmit the user interface data set via a wireless communication protocol.

11. The mobile telecommunications terminal according to claim 10, comprising:
a display, and
a memory operatively coupled to the display and comprising figure data corresponding to one or more figures presentable on the display,
wherein the control unit is adapted to use said configuration data for pointing out at least a portion of said figure data in the memory and to display the at least a portion of said figure data on the display.

12. The mobile telecommunications terminal according to claim 11, wherein the control unit is adapted to use said configuration data for defining one or more coordinates on the display and to display the at least a portion of said figure data on the display at said coordinates.

13. The mobile telecommunications terminal according to claim 10, comprising:
an audio unit,
a memory operatively coupled to the audio unit and comprising audio data corresponding to one or more audio sequences,
wherein the control unit is adapted to use said configuration data for pointing out at least a portion of said audio data in the memory and to play back the at least a portion of said audio data in the audio unit.

14. The mobile telecommunications terminal according to claim 11, wherein the control unit is adapted to generate said user interface data set from the at least a portion of said figure data.

15. The mobile telecommunications terminal according to claim 13, wherein the control unit is adapted to generate said user interface data set from the at least a portion of said audio data.

16. The mobile telecommunications terminal according to claim 10, comprising:
a housing, and
one or more controls arranged in the mobile telecommunications terminal, said controls being accessible from the outside of the housing and coupled to the input unit,
wherein the input unit is adapted to generate the configuration data as a result of an actuation of at least one of the one or more controls.

17. The mobile telecommunications terminal according to claim 10, wherein the input unit is adapted to communicate with a personal computer and to receive the configuration data from the computer.

18. The mobile telecommunications terminal according to claim 10, comprising:
display means, and
a memory operatively coupled to the display means and comprising visualization data presentable by means of the display means,
wherein the control unit is adapted to use said configuration data for pointing out at least a portion of said visualization data in the memory for presentation of the at least a portion of said visualization data by means of the display.
